(19) United States
(12) Patent Application Publication
(10) Pub. No.: US 2013/0179768 A1
(43) Pub. Date: Jul. 11, 2013

(54) Differentiated Information Display For Certified and Uncertified Web Page Versions

(71) Applicant: Adam Roberts, Moncure, NC (US)

(72) Inventor: Adam Roberts, Moncure, NC (US)

(73) Assignee: International Business Machines Corporation, Armonk, NY (US)

(21) Appl. No.: 13/343,959

(22) Filed: Jan. 5, 2012

(51) Int. Cl. G06F 17/00

(52) U.S. Cl. 715/234

(57) ABSTRACT

Different certified and uncertified versions of a web page document are provided in response to user preferences. In response to verifying that information content on an input web page meets a reviewing standard, a certification is built into the input web page, the information content locked into a read-only mode and the locked web page content published as a certified version of the web page including the certificate. The web page may also be published as an original uncertified version that does not include the certificate. One or more of the certified and original uncertified versions of the web page are selected and displayed as a function of a presence or an absence of the certificate as required by a user setting of a programmable browser device. The displaying may visually indicate to the user a certification status of the displayed web page.

### BACKGROUND

Embodiments of the present invention relate to differentiated web page displays for conveying and updating web page information in a secure format.

Instructional material may be delivered to student end-users through web pages and other electronic document delivery formats and systems. For example, a student may log in to a secure server through internet application interface and receive textbook materials on-line, generally after paying a limited time license to access the material. Such secure access methods enable book publishers and other providers to exert a high degree of control over the information conveyed. They may verify the content before release, control the age of released versions, the information and the timeline for updating the information by subsequent versions, and the audience or end-user population.

In the alternative, students may also use browser applications to search the internet, libraries and other sources to access a wide variety of public domain information useful for classroom or certification assignments, much of which is free of access cost or at a lower cost than restricted server methods. One popular form of public domain sources are “wiki” web pages, wherein original content is generated and edited by viewers and users of a given webpage, for example Wikipedia.org. Wiki page formats can quickly generate rich and copious amounts of information in proportion to the quantity and quality of the site users. The information may be more rapidly revised and updated by a wide variety of users essentially in real-time, as the web pages are not fixed and immutable published documents subject to the limited updating date cycles common in secure textbook server applications. As large numbers of viewers and users may be available to monitor, comment and revise the wiki web page content, a large amount of information may be produced at little cost to the wiki page host. This results in a wide variety of dynamic information that is freely available, and often more timely and responsive to current events or changes in relevant discipline fields, compared to static, secure textbook site materials.

Accordingly, wiki pages and other public domain web sources are popular with students and frequently relied upon for instructional material and other data. However, information on many public domain sites is unverified. Many wiki sites have limited or no monitors actively verifying the information conveyed thereon, resulting in inaccurate and sometimes intentionally false information postings. As students are often new to the subjects at issue, they are often unable to discern good information from bad relative to the topic forming the basis of their search, and are vulnerable to utilizing inaccurate or misleading information, and the use of wikis may thereby be detrimental to the student's work. As a result, many educators have forbidden their students from citing to or otherwise relying upon wiki sources and other public domain content sites in their coursework. This may help to ensure the veracity of the sources used, and prevent novice students from being mislead within their coursework, but at a cost of limiting the amounts and variety of content available to the student.

### BRIEF SUMMARY

In one embodiment of the present invention, a method provides different certified and uncertified versions of a web page document in response to user preferences. In response to a processing unit verifying that information content on an input web page meets a certification-entity reviewing standard, the processing unit builds a certification into the input web page, locks the information content into a read-only mode and publishes the locked web page content as a certified version of the web page comprising the certificate. The web page is published as an original uncertified version of the web page that does not comprise the certificate, in response to verifying that the information content on the input web page does not meet the certification entity reviewing standard, or in response to a direct input of the information content on the input web page that may be received prior to the verifying step. In response to an end user request to access the input web page, one or more of the certified and original uncertified versions of the web page are selected as a function of a presence or an absence of the certificate as required by a user setting of a programmable browser device. The selected version or versions are displayed via the programmable browser device to the end user as a displayed representation of the input web page. The displaying visually indicates to the user a certification status of the displayed web page as a function of the presence or the absence of the certificate in the selected version or versions of the page.

In another embodiment, a method provides a service for displaying different certified and uncertified versions of a web page document in response to user preferences. The method includes integrating computer-readable program code into a computer system comprising a processing unit, a computer readable memory and a computer readable tangible storage device. Computer readable program code is embodied on the computer readable tangible storage device and comprises instructions that, when executed by the processing unit via the computer readable memory, cause the processing unit to verify that information content on an input web page meets a certification entity reviewing standard, build a certification into the input web page, lock the information content into a read-only mode and publish the locked web page content as a certified version of the web page comprising the certificate. The web page is published as an original uncertified version of the web page that does not comprise the certificate, in response to verifying that the information content on the input web page does not meet the certification entity reviewing standard, or in response to a direct input of the information content on the input web page that may be received prior to the verifying step. In response to an end user request to access the input web page, one or more of the certified and original uncertified versions of the web page are selected as a function of a presence or an absence of the certificate as required by a user setting of a programmable browser device. The selected version or versions are displayed via the programmable browser device to the end user as a displayed representation of the input web page. The displaying visually indicates to the user a certification status of the displayed web page as a function of the presence or the absence of the certificate in the selected version or versions of the page.

In another embodiment, a system has a processing unit, computer readable memory and a tangible computer-readable storage device with program instructions, wherein the processing unit, when executing the stored program instructions verifies that information content on an input web page meets a certification entity reviewing standard, builds a certification into the input web page, locks the information content into a read-only mode and publishes the locked web page content as a certified version of the web page comprising the certificate. The web page is published as an original uncertified version of the web page that does not comprise the certificate, in response to verifying that the information content on the input web page does not meet the certification entity reviewing standard, or in response to a direct input of the information content on the input web page that may be received prior to the verifying step. In response to an end user request to access the input web page, one or more of the certified and original uncertified versions of the web page are selected as a function of a presence or an absence of the certificate as required by a user setting of a programmable browser device. The selected version or versions are displayed via the programmable browser device to the end user as a displayed representation of the input web page. The displaying visually indicates to the user a certification status of the displayed web page as a function of the presence or the absence of the certificate in the selected version or versions of the page.

In another embodiment, an article of manufacture has a tangible computer-readable storage device with computer readable program code embodied therewith, the computer readable program code comprising instructions that, when executed by a computer processing unit, cause the computer processing unit to verify that information content on an input web page meets a certification entity reviewing standard, build a certification into the input web page, lock the information content into a read-only mode and publish the locked web page content as a certified version of the web page comprising the certificate. The web page is published as an original uncertified version of the web page that does not comprise the certificate, in response to verifying that the information content on the input web page does not meet the certification entity reviewing standard, or in response to a direct input of the information content on the input web page that may be received prior to the verifying step. In response to an end user request to access the input web page, one or more of the certified and original uncertified versions of the web page are selected as a function of a presence or an absence of the certificate as required by a user setting of a programmable browser device. The selected version or versions are displayed via the programmable browser device to the end user as a displayed representation of the input web page. The displaying visually indicates to the user a certification status of the displayed web page as a function of the presence or the absence of the certificate in the selected version or versions of the page.

### BRIEF DESCRIPTION OF THE SEVERAL VIEWS OF THE DRAWINGS

These and other features of this invention will be more readily understood from the following detailed description of the various aspects of the invention taken in conjunction with the accompanying drawings in which:

FIG. 1 is a block diagram illustration of an embodiment of a method, process or system for providing different certified and uncertified versions of a web page document in response to user preferences according to the present invention.

FIGS. 2A, 2B and 2C are diagrammatic illustrations of versions of an input web page for display according to an embodiment of the present invention.

FIG. 3 is a block diagram illustration of a computerized implementation of an embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program code embodied therein, for example, in a baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including, but not limited to, wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

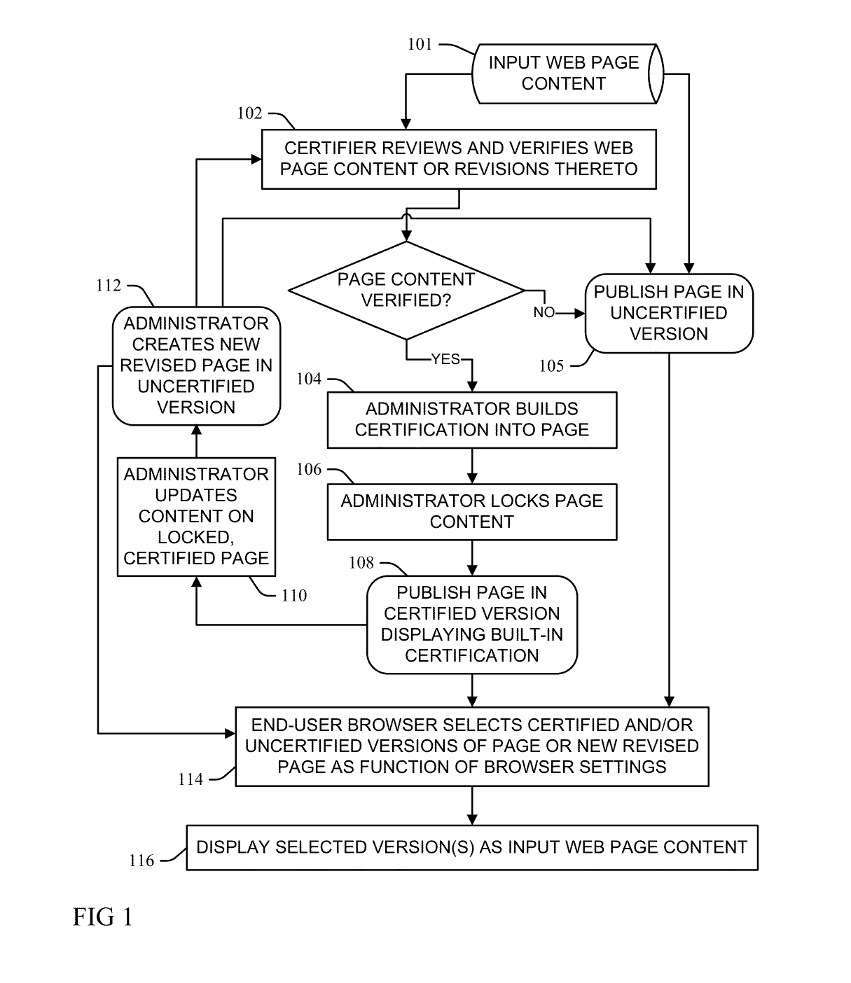

FIG. 1 illustrates an embodiment of the present invention for providing different certified and uncertified versions of a web page document in response to user preferences. At 102 a certification entity (teacher or professor, group of teachers/professors in a department of a school, professional organization of instructors drawn from multiple schools, governing educational board or other body, etc.) reviews content on a web page 101 submitted by an administrator of the web page (publisher, content provider, etc.) The web page content 101 may also be directly published as an uncertified web page at 105.

The certification entity review at 102 verifies whether the content 101 meets certain standards (veracity of sources, accuracy of data or other information, etc.). If the certification entity verifies the content at 102, then at 104 the administrator builds a certification into the page (or its Uniform Resource Locator (URL) address, etc.) and at 106 locks the information content into a read-only mode page, wherein neither the site administrator nor a user of the page may change, revise or alter the information contents on the page. The page is then published in a certified version at 108, which optionally visually displays the certification to an end user viewing the page in a subsequent browser viewing.

Otherwise, if the certification entity does not verify the content at 102, than at 105 the administrator may make the page available in an uncertified version of the page, which may optionally display notice to an end user viewing the page as to the lack of the certification in a subsequent browser viewing. This may comprise a new, initial publication of the input web page content 101 at 105, if the administrator of the web page defers publication until the review and decision process at 102 is complete. Alternatively, this may be a continuation or revision of a previous publication at 105 generated from direct submission of the web page input 101. This alternative option still enables an opportunity to certify the input at 102, yet wherein the general end-user audience need not wait for the certification process to be completed before an initial uncertified version is released at 105. This avoids needless delays in the eventual publication of uncertified versions at 105 when the page does not meet certification requirements, cannot be verified, or where the verification will take a long period of time.

In the event of a change to the page content data at 110 (revision, data update, new data addition, etc.), the administrator creates a second alternate version of the certified page with the alterations or corrections at 112. Such revisions may also be made directly available to end users without the built-in certification at 105, for example visually displaying notice as to the lack of the certification to an end user viewing the page in a subsequent browser viewing. The administrator may also submit the updated page to the certification entity for the content review, verification and publishing processes commencing at 102, which enables the updated page to be published in either a verified or certified version. This new version may replace the prior version, which may be archived. The updated version may also be maintained in an uncertified version published at 105 and provided for viewing as an alternate of the certified version of the original.

The site administrator makes both certified 108 and uncertified 105 web page publications available for end user access at 114. In response to an end user request to access the input web page, an end user programmable browser device selects one (or in some cases, both) of the certified and uncertified versions of the web page as a function of a presence (or an absence of the certificate) as required by a security, certification or preference setting of the user's programmable browser device. The selected version or versions are displayed at 116 to the end user as a displayed representation of the input web page. Said displaying may also visually indicate to the user a certification status of the displayed web page content as a function of the presence or the absence of the certificate in the selected version(s) of the page.

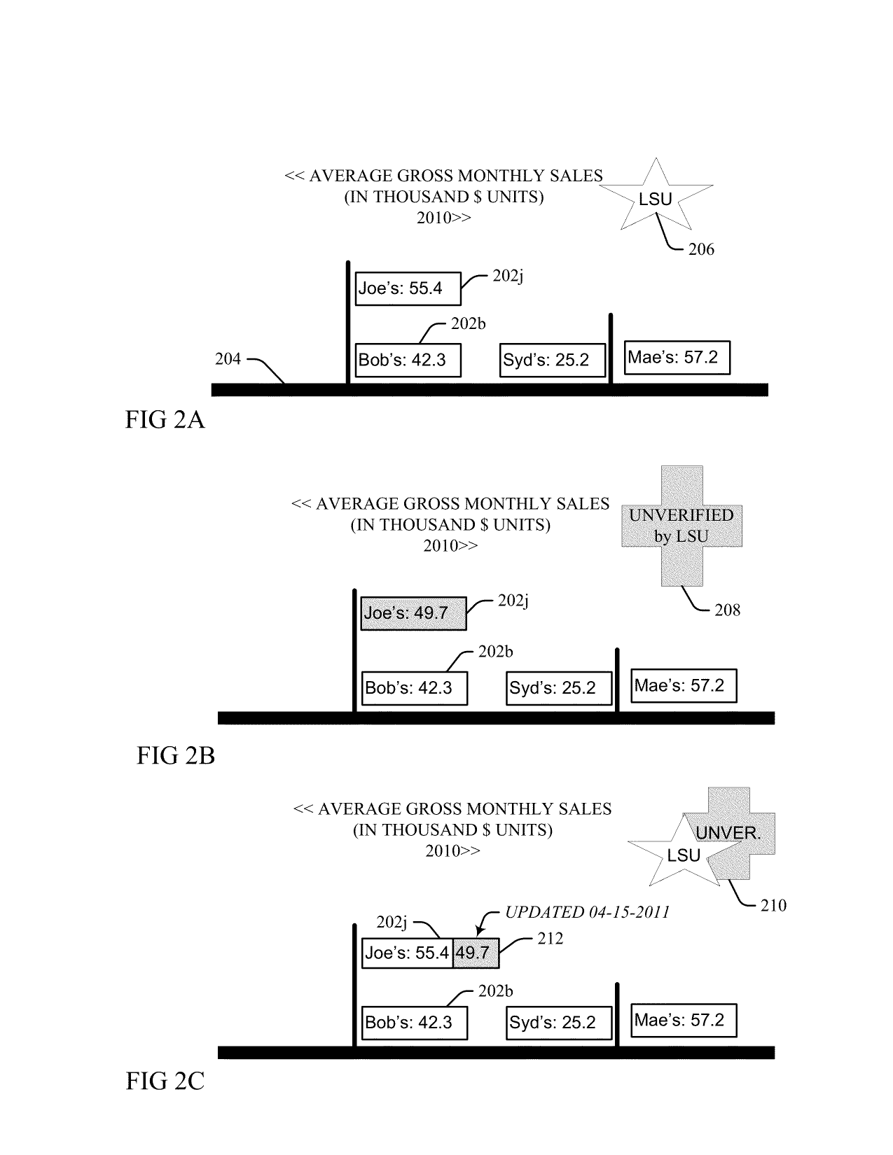

FIGS. 2A, 2B and 2C illustrate some different exemplary options for selecting and displaying the content of the different selected document versions to an end-user through browser web page displays as provided by 114 and 116 of FIG. 1. FIG. 2A illustrates the certified version 108 of a web page wherein a plurality of icons 202 each represent different business data objects uniquely plotted on streets 204 of a two-dimensional map a specified geographic area (for example, through using variable street address data of the underlying relational structures). In the present example each of the icons 202 in the initial display at FIG. 2 have a similar initial respective two-dimensional graphic display appearance: common rectangular icons 202 are used having the same shape and level of color channel shading (none). Each of the icons identify the business data objects they represent by business name (Joe's, Bob's, etc.) and their respective average gross monthly sales in dollars over 2010: for example, Joe's monthly average is reported by it's icon 202j as $55,400.00, and Bob's monthly average as reported by it's icon 202b is $42,300.00. The page view of FIG. 2A also displays a certification seal or stamp icon 206 visually conveying to the end user that the data on the page has been fixed (locked) and certified by a certification entity, in this example by “Large State University” represented by the initials “LSU” within the icon 206. In other embodiments, the certified web pages are marked with certification labels at the top or bottom of each page or the certification indication is imbedded into the source code of the web site for recognition by a browser or other application associated with the end user, and still other techniques will be apparent to one skilled in the art. Thus, in the present example, an end user student of LSU with a browser configured to select and display the certified version is visually informed that the data herein has been verified by the university and may be relied upon for coursework at that university.

FIG. 2B illustrates an example of an alternate uncertified web page built by the administrator at 105, or the revised, uncertified update page built at 112 in response to a data update. Joe's monthly average $49,700.00 has not been verified by the certification entity at 102, as indicated by an “unverified” icon 208 that visually conveys to the end user that the data on this page is unverified by Large State University. Thus, an end user student knows that all or part of the page data may not be relied upon for coursework at LSU. In some embodiments, verified and unverified material within the page may be distinguished from other verified items: in this example, only Joe's data is unverified (perhaps updated at 110 and not yet verified, or LSU could not verify the data at 102), and accordingly, Joe's icon 202j is shaded to distinguish it from the data in Bob's icon data 202b.

In response to a request for the web page by the end-user at 114, embodiments may select and display either the certified version of the page shown in FIG. 2A, or the uncertified version of the page of FIG. 2B, or both, for example, side-by-side in a single display window. FIG. 2C illustrates another alternative in which the two versions are merged into a marked-up view that indicates or summarizes differences between the versions. This is indicated here by a merger icon 210 that visually conveys to the end user that some of the data on this page is verified by Large State University, with the other unverified (“Unver.”) items called out by different icon shading. In this example, the unverified data is the update to Joe's gross monthly sales data, which is shown within an additional icon field 212 added on to the original, verified icon data 202j, and wherein the date of the update is indicated. Thus, an end user student knows that the rest of the (un-shaded) icon data (for example, Bob's data in 202b) may be relied upon as certified for coursework at LSU, but wherein the update information shown with respect to Joe's is unverified. In other examples, differences between the certified web page and the newer version may be indicated through tracked changes conventions (for example, showing deleted text items in strikethrough, added items in underline, etc.), or through use of a scrolling side bar.

Prior art methods sift web page content in a binary fashion for security reasons, and either block or allow a given web page regardless of version status. In contrast, the present embodiment selects and displays at 114 one or more versions of a page. This enables the end user, the certifying entity or the web page site administrator to choose which of two versions of a page are displayed to the end user, if not both versions, and also to determine and display differences in the content thereon. Rather than simply replace a prior version when content is modified, additional pages may be created and marked as uncertified. This enables the administrator to serve more than one type of end user, for example providing only the verified version to a first group of end-users for which trustworthiness is more important than reflecting new data (for example, for students studying a history wherein new theories are not germane to critical event dates). A second, updated but unverified version may be served to a second group for which current data is more important than data verification (for example, for students participating in a stock market simulation, wherein they may rely on alternative sources to verify latest economic data).

Selecting either or both versions of the web page at 114 may be accomplished by a user via security, certification or preference settings in a browser application. In one embodiment, clicking a link for the page content causes a user to be presented with a choice, for example, via a dialog box. The choice may also be made automatically through user or certification entity settings to the user's browser, for example via gateway, pay wall or other applications, in some examples as default selections that may be manually confirmed or overridden by the user. The user may thereby select an original, certified data page, or instead a newer page version with the latest updates and with notice and acceptance of the fact that the data has not been verified or otherwise guaranteed as acceptable by the certification entity.

Thus, the present embodiment allows both for fixing of page content to acquire certification of trustworthiness by authoritative third parties, and for improvement to the content through real-time flow of new data on data subjects within the web page. Rather than allow the verified page content to grow stale or become obsolete or incorrect through failure to reflect updated data while awaiting the completion of additional verifications processes 102-104-106-108 by the certification entity (and thus to lose value to the end-user), embodiments may rapidly display updates (for example, in real-time, as they occur) to an end user. The user may therefore be given newer, more up-to-date information in a timely fashion, while maintaining control of the integrity of the page data as a whole by differentially calling out and distinguishing the new material from the verified information.

Thus, a participating web site administrator may agree to build a certification into their page content that is easily viewable by students on the page itself stating the data is certified as accurate (optionally through or on a particular date). The administrator may make a plurality of versions of given web page available to an end user, or it may publish only latest versions marked accordingly to indicate the state of verification of all or part of the page content. When changes are made on a site that has been previously certified, the certification entity can review the updated site and accept it with a certification, ignore the changes and leave the page uncertified, or request additional changes on the page to make it certifiable. In some examples, the governing educational body may be made aware via electronic notification that a change has been made to a “certified as accurate” page and a new certification request can be automatically queued for completion.

Prior art fact-checking verification of public domain information is generally accomplished through limiting end users to pages generated by said fact-checkers. For example, see the content pages generated by fact-checking organizations like FactCheck.org (sponsored by the Annenberg Public Policy Center of the University of Pennsylvania), or PolitiFact.com (a service of the St. Petersburg Times newspaper owned by the Times Publishing Company). In contrast, embodiments of the present invention may extend the concept beyond secure, controlled web pages generated and maintained by the certification entity to any public domain web page generated by participating administrators. Such sites may agree voluntarily to be reviewed by a certification entity, and then freeze content that has been reviewed and approved as accurate.

In some embodiments, the web page URL's of the different versions differ by the absence or presence of a designated text marker within their respective URL's, each version thus interpreted by a browser as a different page via their different URL's. This enables differentiated viewing by configuring the end-user browser to be able to view only one of the two kinds of URL's. For example, for a website page entitled “testpage1” a certified page version may be marked by using its name within it's URL address and without any other text or marker (“administrator.com/testpage1”), while a newer, updated page version that is not certified may be marked by adding signifying text at the end of it's URL (for example, “administrator.com/testpage1_nocert”). In this example, if a “certification” add-on loaded onto an end user browser is enabled and set to display the certified version of the web page, then the URL of the certified page version (“administrator.com/testpage1”) is loaded. In the converse, if the add-on is instead set to show the latest, un-verified version, then the URL of the un-certified page version (“administrator.com/testpage1_nocert”) is loaded. In other embodiments, it is the certified version that is instead marked with the additional marker (for example, “_cert”), wherein absence of the marker indicates an uncertified version. Moreover, some embodiments may enable viewing of the other versions as available backup web sites to the preferred version.

In other embodiments, the certified and non-certified versions of the web page may share the same URL, but wherein the certified version of the web page has a certified stamp added to the source code. For example, locking the certified web page at 106 may comprise imbedding a certification marker into the web page source code within a designated non-display text area of the page (for example, within a comment area or another keep-out area of the document text not generally revealed to the user in rendering the document content in a browser view) and then rendering the page as a read-only document. Thus, a web browser add-on may choose which version to display in response to a search of the designated areas of the respective page versions for the presence of the marker.

Student web browsers utilizing with the add-on can choose between loading either a standard, non-certified version or a certified version of a web site, or both side-by-side, or merged, depending on the particular filter enabled. Web browsers lacking the add-on, or wherein it is not enabled, may simply see a page that the web site administrator chooses for them, in one aspect passing control of the site content back to the administrator. Thus, a site administrator concerned with building a reputation for verified data (perhaps at the expense of delaying updates until the verification process can be complete) may choose to make standard web browsers without the add-on enabled see only the certified page version. A site more concerned with offering the latest data can instead choose to make the non-certified data as the default.

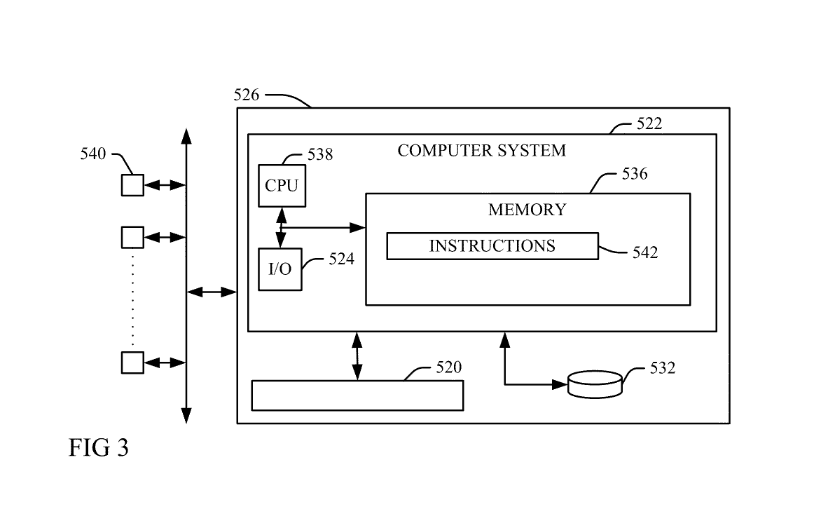

Referring now to FIG. 3, an exemplary computerized implementation of an embodiment of the present invention includes a computer system or other programmable device 522 in communication with network data sources 540 for providing the web page data 101 or updated page data 112. Instructions 542 reside within computer readable code in a computer readable memory 536, or in a computer readable storage system 532, or other tangible computer readable storage medium that is accessed through a computer network infrastructure 526 by a processing unit (CPU) 538. Thus, the instructions, when implemented by the processing unit (CPU) 538, cause the processing unit (CPU) 538 to perform interactive analysis of data objects within a display as described above with respect to FIG. 1, and in some embodiments of the present invention also with respect to one or more of FIGS. 2A, 2B and 2C.

Embodiments of the present invention may also perform process steps of the invention on a subscription, advertising, and/or fee basis. That is, a service provider could offer to integrate computer-readable program code into the computer system 522 to enable the computer system 522 to perform interactive analysis of data objects within a display as described above with respect to FIGS. 1, 2A, 2B, 2C and 3. The service provider can create, maintain, and support, etc., a computer infrastructure such as the computer system 522, network environment 526, or parts thereof, that perform the process steps of the invention for one or more customers. In return, the service provider can receive payment from the customer(s) under a subscription and/or fee agreement and/or the service provider can receive payment from the sale of advertising content to one or more third parties. Services may comprise one or more of: (1) installing program code on a computing device, such as the computer device 522, from a tangible computer-readable medium device 520 or 532; (2) adding one or more computing devices to a computer infrastructure; and (3) incorporating and/or modifying one or more existing systems of the computer infrastructure to enable the computer infrastructure to perform the process steps of the invention.

The terminology used herein is for describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising” when used in this specification, specify the presence of stated features, integers, steps, operations, elements, and/or components, but do not preclude the presence or addition of one or more other features, integers, steps, operations, elements, components, and/or groups thereof. Certain examples and elements described in the present specification, including in the claims and as illustrated in the Figures, may be distinguished or otherwise identified from others by unique adjectives (e.g. a “first” element distinguished from another “second” or “third” of a plurality of elements, a “primary” distinguished from a “secondary” one or “another” item, etc.) Such identifying adjectives are generally used to reduce confusion or uncertainty, and are not to be construed to limit the claims to any specific illustrated element or embodiment, or to imply any precedence, ordering or ranking of any claim elements, limitations or process steps.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for providing different certified and uncertified versions of a web page document in response to user preferences, the method comprising:
in response to verifying via a processing unit that information content on an input web page meets a certification entity reviewing standard, the processing unit building a certification into the input web page, locking the information content into a read-only mode, and publishing the locked web page content as a certified version of the web page comprising the certificate;
publishing the web page as an original uncertified version of the web page that does not comprise the certificate, in response to verifying via the processing unit that the information content on the input web page does not meet the certification entity reviewing standard, or in response to a direct input of the information content on the input web page that is received prior to the step of verifying;
in response to an end user request to access the input web page, selecting at least one of the certified and original uncertified versions of the web page as a function of a presence or an absence of the certificate as required by a user setting of a programmable browser device; and
displaying via the programmable browser device the selected at least one of the certified and original uncertified versions to the end user as a displayed representation of the input web page, wherein the displaying visually indicates to the user a certification status of the displayed web page as a function of the presence or the absence of the certificate in the selected at least one of version of the page.

2. The method of claim 1, further comprising:
in response to an update to the information content in the locked certified version of the input web page, revising the information content that is locked and publishing the revised information content without the certificate as an updated uncertified version of the web page that does not comprise the certificate; and
wherein the step of selecting the at least one of the certified and uncertified versions of the web page in response to the end user request to access the input web page further comprises selecting at least one of the original uncertified version, the updated uncertified version and the certified version of the web page.

3. The method of claim 2, wherein the step of selecting the at least one version of the web page in response to the end user request to access the input web page further comprises selecting the certified version of the web page; and
wherein the step of displaying via the programmable browser device the selected certified version to the end user as the displayed representation of the input web page further comprises visually indicating to the user the certification status of the displayed web page as the function of the presence of the certificate in the selected certified version of the page by visually displaying a certification seal icon on the displayed web page content.

4. The method of claim 2, wherein the step of selecting the at least one version of the web page in response to the end user request to access the input web page further comprises selecting the original uncertified version or the updated uncertified version of the web page; and
wherein the step of displaying via the programmable browser device the selected uncertified version to the end user as the displayed representation of the input web page further comprises visually indicating to the user the certification status of the displayed web page as the function of the absence of the certificate in the selected uncertified version of the page by visually displaying a notice that the displayed web page content is unverified.

5. The method of claim 2, wherein the step of selecting the at least one version of the web page in response to the end user request to access the input web page further comprises selecting the certified version and at least one of the uncertified original version and the uncertified updated version of the web page; and
wherein the step of displaying via the programmable browser device the selected versions to the end user as the displayed representation of the input web page further comprises displaying a merged web page that visually indicates differences between certified content and uncertified content of the respective versions.

6. The method of claim 5, wherein the displaying the merged web page that visually indicates differences between certified content and uncertified content of the respective versions further comprises:
displaying a marked-up view that indicates a difference between corresponding content items of the versions through a visually distinctive text emphasis and a text indicator of a date of revision resulting in the difference between the corresponding content items.

7. The method of claim 2, wherein the step of publishing the locked web page content as the certified version of the web page comprising the certificate comprises inserting the certificate in a uniform resource locator address of the certified version that causes the end user programmable browser device to navigate to the certified version; and
wherein the step of publishing the web page as the uncertified version of the web page that does not comprise the certificate comprises omitting the certificate from a uniform resource locator address of the uncertified version that is different from the certified version uniform resource locator address and causes the end user programmable browser device to navigate to the uncertified version.

8. The method of claim 2, wherein the step of publishing the locked web page content as the certified version of the web page comprising the certificate comprises imbedding a certification marker into web page source code within a designated non-display text area of the page; and
wherein the step of selecting the at least one of the certified and uncertified versions of the web page in response to the end user request to access the input web page further comprises selecting at least one of the uncertified updated version and the certified version of the web page as a function of searching the designated areas of the respective uncertified and certified page versions for the presence of the marker.

9. A method of providing a service for displaying different certified and uncertified versions of a web page document in response to user preferences, the method comprising:
integrating computer-readable program code into a computer system comprising a processing unit, a computer readable memory and a computer readable tangible storage device, wherein the computer readable program code is embodied on the computer readable tangible storage device and comprises instructions that, when executed by the processing unit via the computer readable memory, cause the processing unit to:
in response to verifying that information content on an input web page meets a certification entity reviewing standard, build a certification into the input web page, lock the information content into a read-only mode, and publish the locked web page content as a certified version of the web page comprising the certificate;
publish the web page as an original uncertified version of the web page that does not comprise the certificate, in response to verifying that the information content on the input web page does not meet the certification entity reviewing standard, or in response to a direct input of the information content on the input web page that is received prior to the step of verifying;
in response to an end user request to access the input web page, select at least one of the certified and original uncertified versions of the web page as a function of a presence or an absence of the certificate as required by a user setting of a programmable browser device; and
cause a display via the programmable browser device of the selected at least one of the certified and original uncertified versions to the end user as a displayed representation of the input web page, wherein the display visually indicates to the user a certification status of the displayed web page as a function of the presence or the absence of the certificate in the selected at least one version of the page.

10. The method of claim 9, wherein the computer readable program code instructions, when executed by the processing unit via the computer readable memory, further cause the processing unit to:
in response to an update to the information content in the locked certified version of the input web page, revise the information content that is locked and publish the revised information content without the certificate as an updated uncertified version of the web page that does not comprise the certificate; and
select the at least one of the certified and uncertified versions of the web page in response to the end user request to access the input web page by selecting at least one of the original uncertified version, the updated uncertified version and the certified version of the web page.

11. The method of claim 10, wherein the computer readable program code instructions, when executed by the processing unit via the computer readable memory, further cause the processing unit to:
cause the display via the programmable browser device of the selected certified version to the end user as the displayed representation of the input web page to visually indicate to the user the certification status of the displayed web page as the function of the presence of the certificate in the selected certified version of the page by visually displaying a certification seal icon on the displayed web page content; and
cause the display via the programmable browser device of the selected uncertified version to the end user as the displayed representation of the input web page further to visually indicate to the user the certification status of the displayed web page as the function of the absence of the certificate in the selected uncertified version of the page by visually displaying a notice that the displayed web page content is unverified.

12. The method of claim 10, wherein the computer readable program code instructions, when executed by the processing unit via the computer readable memory, further cause the processing unit to:
select the at least one version of the web page in response to the end user request to access the input web page further by selecting the certified version and at least one of the uncertified original version and the uncertified updated version of the web page; and
cause the display via the programmable browser device of the selected versions to the end user as the displayed representation of the input web page to display a merged web page that visually indicates differences between certified content and uncertified content of the respective versions.

13. The method of claim 10, wherein the computer readable program code instructions, when executed by the processing unit via the computer readable memory, further cause the processing unit to:
publish the locked web page content as the certified version of the web page comprising the certificate by inserting the certificate in a uniform resource locator address of the certified version that causes the end user programmable browser device to navigate to the certified version; and
publish the web page as the uncertified version of the web page that does not comprise the certificate by omitting the certificate from a uniform resource locator address of the uncertified version that is different from the certified version uniform resource locator address and that causes the end user programmable browser device to navigate to the uncertified version.

14. The method of claim 10, wherein the computer readable program code instructions, when executed by the processing unit via the computer readable memory, further cause the processing unit to:
publish the locked web page content as the certified version of the web page comprising the certificate by imbedding a certification marker into web page source code within a designated non-display text area of the page; and
select the at least one of the certified and uncertified versions of the web page in response to the end user request to access the input web page by selecting at least one of the uncertified updated version and the certified version of the web page as a function of searching the designated areas of the respective uncertified and certified page versions for the presence of the marker.

15. A system, comprising:
a processing unit in communication with a computer readable memory and a tangible computer-readable storage device;
wherein the processing unit, when executing program instructions stored on the tangible computer-readable storage device via the computer readable memory:
in response to verifying that information content on an input web page meets a certification entity reviewing standard, builds a certification into the input web page, locks the information content into a read-only mode, and publishes the locked web page content as a certified version of the web page comprising the certificate;
publishes the web page as an original uncertified version of the web page that does not comprise the certificate, in response to verifying that the information content on the input web page does not meet the certification entity reviewing standard, or in response to a direct input of the information content on the input web page that is received prior to the step of verifying;
in response to an end user request to access the input web page, selects at least one of the certified and original uncertified versions of the web page as a function of a presence or an absence of the certificate as required by a user setting of a programmable browser device; and
causes a display via the programmable browser device of the selected at least one of the certified and original uncertified versions to the end user as a displayed representation of the input web page, wherein the display visually indicates to the user a certification status of the displayed web page as a function of the presence or the absence of the certificate in the selected at least one version of the page.

16. The system of claim 15, wherein the processing unit, when the executing program instructions stored on the tangible computer-readable storage device via the computer readable memory, further:
in response to an update to the information content in the locked certified version of the input web page, revises the information content that is locked and publish the revised information content without the certificate as an updated uncertified version of the web page that does not comprise the certificate; and
selects the at least one of the certified and uncertified versions of the web page in response to the end user request to access the input web page by selecting at least one of the original uncertified version, the updated uncertified version and the certified version of the web page.

17. The system of claim 16, wherein the processing unit, when the executing program instructions stored on the tangible computer-readable storage device via the computer readable memory, further:
causes the display via the programmable browser device of the selected certified version to the end user as the displayed representation of the input web page to visually indicate to the user the certification status of the displayed web page as the function of the presence of the certificate in the selected certified version of the page by visually displaying a certification seal icon on the displayed web page content; and
causes the display via the programmable browser device of the selected uncertified version to the end user as the displayed representation of the input web page further to visually indicate to the user the certification status of the displayed web page as the function of the absence of the certificate in the selected uncertified version of the page by visually displaying a notice that the displayed web page content is unverified.

18. The system of claim 16, wherein the processing unit, when the executing program instructions stored on the tangible computer-readable storage device via the computer readable memory, further:
selects the at least one version of the web page in response to the end user request to access the input web page further by selecting the certified version and at least one of the uncertified original version and the uncertified updated version of the web page; and
causes the display via the programmable browser device of the selected versions to the end user as the displayed representation of the input web page to display a merged web page that visually indicates differences between certified content and uncertified content of the respective versions.

19. The system of claim 16, wherein the processing unit, when the executing program instructions stored on the tangible computer-readable storage device via the computer readable memory, further:
publishes the locked web page content as the certified version of the web page comprising the certificate by inserting the certificate in a uniform resource locator address of the certified version that causes the end user programmable browser device to navigate to the certified version; and
publishes the web page as the uncertified version of the web page that does not comprise the certificate by omitting the certificate from a uniform resource locator address of the uncertified version that is different from the certified version uniform resource locator address and that causes the end user programmable browser device to navigate to the uncertified version.

20. The system of claim 16, wherein the processing unit, when the executing program instructions stored on the tangible computer-readable storage device via the computer readable memory, further:
publishes the locked web page content as the certified version of the web page comprising the certificate by imbedding a certification marker into web page source code within a designated non-display text area of the page; and
selects the at least one of the certified and uncertified versions of the web page in response to the end user request to access the input web page by selecting at least one of the uncertified updated version and the certified version of the web page as a function of searching the designated areas of the respective uncertified and certified page versions for the presence of the marker.

21. An article of manufacture, comprising:
a computer readable tangible storage device having computer readable program code embodied therewith, the computer readable program code comprising instructions that, when executed by a computer processing unit, cause the computer processing unit to:
in response to verifying that information content on an input web page meets a certification entity reviewing standard, build a certification into the input web page, lock the information content into a read-only mode, and publish the locked web page content as a certified version of the web page comprising the certificate;
publish the web page as an original uncertified version of the web page that does not comprise the certificate, in response to verifying that the information content on the input web page does not meet the certification entity reviewing standard, or in response to a direct input of the information content on the input web page that is received prior to the step of verifying;
in response to an end user request to access the input web page, select at least one of the certified and original uncertified versions of the web page as a function of a presence or an absence of the certificate as required by a user setting of a programmable browser device; and
cause a display via the programmable browser device of the selected at least one of the certified and original uncertified versions to the end user as a displayed representation of the input web page, wherein the display visually indicates to the user a certification status of the displayed web page as a function of the presence or the absence of the certificate in the selected at least one version of the page.

22. The article of manufacture of claim 21, wherein the computer readable program code instructions, when executed by the computer processing unit, further cause the computer processing unit to:
in response to an update to the information content in the locked certified version of the input web page, revise the information content that is locked and publish the revised information content without the certificate as an updated uncertified version of the web page that does not comprise the certificate; and
select the at least one of the certified and uncertified versions of the web page in response to the end user request to access the input web page by selecting at least one of the original uncertified version, the updated uncertified version and the certified version of the web page.

23. The article of manufacture of claim 22, wherein the computer readable program code instructions, when executed by the computer processing unit, further cause the computer processing unit to:
cause the display via the programmable browser device of the selected certified version to the end user as the displayed representation of the input web page to visually indicate to the user the certification status of the displayed web page as the function of the presence of the certificate in the selected certified version of the page by visually displaying a certification seal icon on the displayed web page content; and
cause the display via the programmable browser device of the selected uncertified version to the end user as the displayed representation of the input web page further to visually indicate to the user the certification status of the displayed web page as the function of the absence of the certificate in the selected uncertified version of the page by visually displaying a notice that the displayed web page content is unverified.

24. The article of manufacture of claim 22, wherein the computer readable program code instructions, when executed by the computer processing unit, further cause the computer processing unit to:
select the at least one version of the web page in response to the end user request to access the input web page further by selecting the certified version and at least one of the uncertified original version and the uncertified updated version of the web page; and
cause the display via the programmable browser device of the selected versions to the end user as the displayed representation of the input web page to display a merged web page that visually indicates differences between certified content and uncertified content of the respective versions.

25. The article of manufacture of claim 22, wherein the computer readable program code instructions, when executed by the computer processing unit, further cause the computer processing unit to:
publish the locked web page content as the certified version of the web page comprising the certificate by inserting the certificate in a uniform resource locator address of the certified version that causes the end user programmable browser device to navigate to the certified version; and
publish the web page as the uncertified version of the web page that does not comprise the certificate by omitting the certificate from a uniform resource locator address of the uncertified version that is different from the certified version uniform resource locator address and that causes the end user programmable browser device to navigate to the uncertified version.
